(19) United States
(12) Patent Application Publication
(10) Pub. No.: US 2001/0055685 A1
(43) Pub. Date: Dec. 27, 2001

(54) Conductive filler and making method

(76) Inventor: Masami Kaneyoshi, Takefu-shi (JP)

Correspondence Address: BIRCH STEWART KOLASCH & BIRCH, PO BOX 747, FALLS CHURCH, VA, 22040-0747, US

(21) Appl. No.: 09/854,587

(22) Filed: May 15, 2001

(30) Foreign Application Priority Data
May 15, 2000 (JP) 2000-141634

(51) Int. Cl. B32B 5/16; B32B 17/02; B32B 23/02; B32B 19/00

(52) U.S. Cl. 428/403; 428/363; 428/404; 428/406

(57) ABSTRACT

A conductive filler is provided in the form of non-conductive particles which are surface coated with a plating layer of copper, copper alloy, nickel or nickel alloy, which is, in turn, coated with an electroplating layer of gold, gold alloy, silver or silver alloy. The conductive powder has a high conductivity, durability, especially oxidation resistance, and a relatively low specific gravity.

This invention relates to a conductive filler which is formulated in rubber and resin compositions to impart conductivity to molded parts thereof.

### BACKGROUND OF THE INVENTION

It is known in the art that by blending conductive powder particles in rubber compositions such as silicone rubber compositions, and molding the compositions, molded rubber parts in their entirety are endowed with conductivity for antistatic and other purposes. Carbon black is traditionally used as the conductive powder. Recently, conductive rubber parts are sometimes used for electrical connection on circuit boards within electronic equipment. A high conductivity is needed in these applications wherein the positive conduction of electricity is contemplated. The additives used for imparting conductivity are highly conductive materials as typified by metal powders. Most metal powders, however, are susceptible to ignition during handling and are readily oxidized to detract from conductivity. Silver powder is often used in practice since it suffers from few of the above problems. However, metal powders including silver powder generally have additional drawbacks of a high specific gravity, irregular and uneven particle shape, and the difficulty of intimate milling in rubber and resin.

To overcome these shortcomings, it was recently developed to metallize core particles of resin or ceramic material. Typically, a nickel coating is applied to the core by electroless plating, and a gold coating is applied to the outermost surface by displacement plating. Gold on the outermost surface, combined with the underlying nickel, ensures conductivity and oxidation resistance. Since the metals are limited to the proximity of the surface, the specific gravity is low. The cost is permissible because of the reduced gold content. Besides, a conductive powder in the form of glass beads surface coated with silver is commercially available from Toshiba Balotini Co., Ltd. and used as a conductive filler having the characteristics of silver.

However, the conductivity of the gold/nickel coated particles is still insufficient in some applications or for particular purposes. One reason is that the displacement plating of gold is difficult to form a truly dense and continuous, that is, non-porous metal layer. On the other hand, the silver-coated particles has the propensity for the silver coating to strip, which imposes restrictions when milled in rubber and resins.

Accordingly, it is desired to improve the conductivity and other filler properties of conductive particles manufactured mainly through an electroless plating step, without significantly increasing the cost of raw material.

### SUMMARY OF THE INVENTION

An object of the invention is to provide a conductive filler having a high conductivity, improved durability, especially oxidation resistance, and a relatively low specific gravity. Another object is to provide a method for preparing the conductive filler.

It has been found that when a plating layer of copper, copper alloy, nickel or nickel alloy is formed on surfaces of non-conductive particles as by electroless plating, and a plating layer of gold or silver is formed thereon by electroplating, the dual-coated particles have a low resistivity, high durability and a lower specific gravity than metal particles and serve as a conductive filler.

In one embodiment, the invention provides a conductive filler comprising non-conductive particles which are coated on their surface with a plating layer of copper, copper alloy, nickel or nickel alloy, which is, in turn, coated with an electroplating layer, preferably of gold, gold alloy, silver or silver alloy.

In another embodiment, the invention provides a method for preparing the conductive filler, comprising the steps of forming a plating layer of copper, copper alloy, nickel or nickel alloy on surfaces of non-conductive particles, feeding and dispersing the coated particles in an electroplating solution, and effecting electroplating at a cathodic current density of 0.01 to 10 A/dm².

### DESCRIPTION OF THE PREFERRED EMBODIMENT

The conductive filler of the invention is based on non-conductive particles (also referred to as core) whose surface is coated with a plurality of metal plating layers. The lower (or inside) one of the metal plating layers is a plating layer of copper, copper alloy, nickel or nickel alloy and the upper (or outside) one is an electroplating layer.

For the non-conductive particles or core to be coated with metal plating layers, a variety of insulating materials may be used, for example, oxides such as silicon oxide, zirconia, aluminum oxide, titanium oxide, yttrium oxide and rare earth oxides, naturally occurring inorganic compounds such as mica and diatomaceous earth, glasses such as sodium silicate glass, and resins such as polyurethane, polystyrene, polycarbonate, phenolic resin, polyamide, polyimide, silicone resin and epoxy resin. Besides, light metals and semiconductors such as silicon, boron, aluminum, magnesium, and silicon carbide are equally useful because a thin passivated oxide film is present on their surface. In general, on use of the inventive conductive filler, about 80 to about 500 parts by weight of the conductive filler is blended and milled with 100 parts by weight of a rubber composition (e.g., silicone rubber composition) or a resin composition (e.g., epoxy resin composition). On such use, to avoid stripping of the plating layers during the milling step, the core should preferably have a certain degree of rigidity. Preferred in this regard are inorganic core materials, especially silicon oxide. It is desired that the core particles do not include those particles having a particle diameter in excess of 150 μm, because such large particles, once milled in rubber or resin, tend to separate out of the rubber or resin. It is more desired to exclude those particles having a particle diameter in excess of 100 μm. In this regard, it is desired that the core be particles having a particle diameter of up to 150 μm, more desirably up to 100 μm, and even more desirably 5 to 50 μm. Most preferably, the particles are substantially spherical because they are readily dispersed uniformly upon milling. In general, particles whose shape is close to sphere are preferred.

On the surface of the core is formed a plating layer of copper or a copper alloy or nickel or a nickel alloy. This plating layer is preferably formed by electroless plating.

Since an insulator is used as the core, a catalyst must be applied thereto in order to initiate electroless plating. To this end, well-known techniques may be used, for example, immersion in a tin (II) chloride solution followed by immersion in a palladium (II) chloride solution, and immersion in a mixed solution of tin chloride and palladium chloride. To facilitate application of the catalyst, the core may be pre-treated, for example, by briefly etching with suitable chemical agents such as strong alkali, mineral acids, and chromic acid; treating with chemical agents possessing both a functional group having affinity to the catalyst metal and a functional group having affinity to the core, such as amino group-bearing silane coupling agents; or mechanical treatment such as plasma treatment.

Where a plating layer of copper or copper alloy is formed as the lower layer of electroless plating, it is preferred to deposit substantially pure copper, i.e., copper of such a degree of purity as to permit inclusion of a minor amount of other elements as the impurity. The electroless copper plating solution used to this end may be of well-known compositions, and commercially available compositions are useful. An exemplary solution may contain a known copper salt such as copper sulfate, copper chloride or copper acetate in a copper concentration of 0.01 to 0.5 mol/dm³. With too high a copper concentration, the bath will have a short lifetime due to spontaneous decomposition. Too low a copper concentration necessitates to make up a more volume of solution so that the volume of plating solution largely varies. Formaldehyde is generally used as the reducing agent although other reducing agents such as hypophosphites and boron compounds may also be used. An appropriate amount of the reducing agent used is 0.1 to 5 moles per mole of the copper salt. To prevent copper ions from precipitating as hydroxide, a complexing agent such as ethylenediaminetetraacetate or tartrate is preferably used in an amount of 0.2 to 5 moles per mole of the copper salt.

For a particular type of core, the adhesion of the electroless copper plating film is weak as compared with the electroless nickel plating film, with the likelihood of stripping. In such an event, an electroless plating layer other than copper or copper alloy may be applied as the undercoat preceding the copper or copper alloy plating layer.

A plating layer of nickel or nickel alloy may also be formed as the lower layer of electroless plating. A choice may be made among nickel and nickel base alloys including pure nickel, nickel-boron, nickel-phosphorus, nickel-boron-phosphorus, and nickel-copper-phosphorus. For ease of electroless nickel plating, nickel-phosphorus alloys having a phosphorus content of 2 to 14% by weight are most preferred. The electroless nickel plating solution may contain a known nickel salt such as nickel sulfate, nickel chloride or nickel acetate in a nickel concentration of 0.01 to 0.5 mol/dm³. With too high a nickel concentration, the bath will have a short lifetime because of precipitation of hydroxide due to pH changes and changes of complexing agent concentration. Too low a nickel concentration necessitates to make up a more volume of solution so that the volume of plating solution largely varies. Also phosphorous reducing agents such as hypophosphorous acid and alkali metal or ammonium salts thereof may be used in an amount of 0.1 to 5 moles per mole of the nickel salt.

The lower layer of electroless plating preferably has a thickness of about 50 to 500 nm, more preferably about 75 to 400 nm. A lower layer of less than 50 nm may not have a conductivity necessary to conduct the subsequent electroplating and the finally coated particles may have poor conductivity as a whole. A lower layer thickness in excess of 500 nm is often economically inexpedient since it gives few additional advantages, but increases the material expense.

It is not critical how to form the electroless plating layer. A choice may be made among a variety of techniques, for example, a technique of directly admitting a core powder into a plating solution obtained by mixing a metal ion, reducing agent, complexing agent, buffer agent and the like, and adjusting the pH and temperature; a technique of admitting a slurry of a core powder in water into the same plating solution as above; and a technique of dispersing a core powder in a plating solution from which some components have been excluded and then adding the excluded components. The plating solution composition may be selected from well-known bath compositions for electroless nickel plating and electroless copper plating.

According to the invention, an electroplating layer is formed to cover the lower layer of copper, copper alloy, nickel or nickel alloy, completing dual coated particles serving as the conductive filler. The electroplating layer is preferably selected from layers of noble metals, especially gold, gold alloys, silver and silver alloys.

Exemplary gold alloys include Au—Cu, Au—Ag, Au—Cu—Ag, Au—Cu—Cd, Au—Cu—Cd—Ag, Au—Ni, Au—Co, and Au—Co—In. Exemplary silver alloys include Ag—Zn and Ag—Cu. The preferred gold or silver alloys contain more than 50%, especially more than 70% by weight of gold or silver.

In forming the electroplating layer, the plating or reaction tank contains an electroplating solution, has an anode and a cathode for conducting direct current through the solution from the exterior, and is preferably equipped with an agitator mechanism for agitating the particles having the lower plating layer formed thereon in the solution so that the particles may be suspended or dispersed in the solution. Electroplating is carried out by feeding a necessary volume of the electroplating solution (such as gold or silver electroplating solution) in the tank, admitting the particles having the lower plating layer formed thereon in the solution, dispersing the particles in the solution, agitating the solution such that the particles may be brought in direct contact with the cathode or in indirect contact with the cathode via those particles in close contact with the cathode, and controlling the cathodic current density.

In order that the particles having the lower layer plated thereon be electrically charged to enable electrodeposition of gold or silver, the cathode must be configured and dimensioned so as to have a relatively large surface area and a sophisticated shape, and the means of agitating the solution be devised so that all the electroless plated particles come in sequent contact with the cathode for an appropriate holding time. Too short a holding time may result in insufficient electrodeposition of gold or silver. Too long a holding time is undesirable because particles having the lower layer plated thereon can strongly adhere to the cathode, that is, composite plating of particles on the cathode can occur. The time of holding particles to the cathode can be controlled by the type and intensity of agitation and also depends on the shape and size of the reaction tank and cathode as well as the specific gravity and diameter of particles. The agitating conditions for optimizing the cathode holding time must be determined by an experiment using an actual reaction tank and particles. Optimum agitating conditions are accomplished, for example, by adjusting the length of an agitator blade to approximately one half of the diameter of the reaction tank and rotating the agitator blade at about 20 to 200 rpm.

The care to be taken during electroplating is to prevent suspended particles from contacting the anode. This is necessary to restrain dissolution of the once electrodeposited coating of gold, silver or the like and even the underlying plating layer. Specifically, this is accomplished by placing an ion exchange membrane around the anode to separate the anode from a surrounding portion of the plating solution. An alternative means, which is chosen depending on the agitation type and the spatial location of the electrodes, is to place a baffle so that suspended particles may not flow in proximity to the anode.

With respect to the electroplating solution such as gold or silver electroplating solution, a choice may be made among prior art well-known compositions including commercially available baths. The anode used herein may be a metal to be plated, that is, gold or silver or the like or a platinum-plated titanium electrode. As the cathode, a platinum-plated titanium electrode is useful as well while various stainless steel electrodes may be used. With respect to the current density, a choice may be made in the range of 0.01 to 10 A/dm² for cathodic current density.

The upper layer of electroplating such as a gold or silver electroplating layer preferably has a thickness of at least 10 nm. A thickness of less than 10 nm may not give a dense continuous film or provide sufficient oxidation resistance. More preferably the gold plating layer has a thickness of about 15 to 50 nm and the silver plating layer has a thickness of about 15 to 200 nm. A layer in excess of 50 nm for gold and in excess of 200 nm for silver is inexpedient because the specific gravity and cost are increased.

The thus obtained conductive filler preferably has a resistivity of up to 15 m Ω-cm, more preferably 0.1 to 10 m Ω-cm, and most preferably 0.1 to 5 m Ω-cm. For the measurement of resistivity (or conductivity), specifically the measurement of resistance of a sample having a standardized volume and shape, constant current potentiometric measurement is conducted by the so-called four terminal method. Since the resistance to be measured is very low, a contact resistance and a thermally induced potential difference between contacts can be non-negligible error factors. It is thus desirable to minimize such error factors and compensate therefor by alternately inverting the current flow.

The conductive filler is advantageously used in various rubber and resin compositions, typically silicone rubber compositions and epoxy resin compositions.

### EXAMPLE

Examples of the invention are given below by way of illustration and not by way of limitation.

### Examples

### Electroless Copper Plating

After 30 g of a spherical silicon oxide powder having a mean particle size of about 10 μm (Silica Ace US-10 by Mitsubishi Rayon Co., Ltd.) was weighed, it was added to 180 cm³ of an aqueous solution of 0.3 g aminoalkylsilane coupling agent (KBM603 by Shin-Etsu Chemical Co., Ltd.). After 30 minutes of agitation at room temperature, the powder was filtered on a Buchner funnel, and washed by spraying a small amount of water.

The silane coupling agent-treated powder was added to 150 cm³ of an aqueous solution containing 3 mmol/dm³ of palladium chloride, 0.05 mol/dm³ of tin (II) chloride and 2.5 mol/dm³ of hydrogen chloride, followed by 10 minutes of agitation. The powder was separated from the mixture by filtration on a Buchner funnel. The powder was washed by spraying 150 cm³ of dilute hydrochloric acid having a concentration of 1 mol/dm³ and further with 100 cm³ of water.

Next the catalyzed powder was dispersed in 135 cm³ of water by agitation, forming a slurry. Separately, 4 dm3 of a plating solution was furnished by dissolving 0.042 mol/dm³ of copper (II) sulfate, 0.026 mol/dm³ of disodium ethylenediaminetetraacetate and 0.096 mol/dm³ of formaldehyde in water, adding an aqueous sodium hydroxide solution thereto for adjusting to pH 12.9 and heating at a temperature of 42° C. With stirring, the slurry was added to this plating solution. While stirring was continued, reaction took place for 15 minutes, depositing an electroless copper plating film as the lower layer. At the end of reaction, the powder was separated by filtration on a Buchner funnel and washed by spraying about 1 dm³ of water.

### Electroless Nickel Plating

A catalyzed powder was obtained by using the same core powder and following the same procedure as in the electroless copper plating. The catalyzed powder was dispersed in 135 cm³ of water by agitation, forming a slurry. Separately, 4 dm³ of a plating solution was furnished by dissolving 0.043 mol/dm³ of nickel sulfate, 0.092 mol/dm³ of sodium hypophospite and 0.05 mol/dm³ of citric acid in water, adding aqueous ammonia thereto for adjusting to pH 8.8 and heating at a temperature of 45° C. With stirring, the slurry was added to this plating solution. While stirring was continued, reaction took place for 15 minutes, depositing an electroless nickel-phosphorus alloy plating film as the lower layer. At the end of reaction, the powder was separated by filtration on a Buchner funnel and washed by spraying about 1 dm³ of water.

### Gold Electroplating

An electrolytic reaction tank having a volume of about dm³ was equipped with an agitating blade, a rod-shaped platinum-coated titanium anode inserted at the center of a cylindrical ion-exchange membrane, and a platinum-coated titanium mesh cathode having a surface area of about 10 dm². In the tank, 3 dm³ of a gold plating solution ECF-66A by N. E. Chemcat Co. (non-cyanide, neutral, gold concentration 10 g/dm³) was admitted and heated at 45° C. The electroless plated powder (resulting from the above electroless copper or nickel plating step) was added to the solution. With agitation at about 100 rpm, an current flow of 5 amperes was conducted for 7 minutes. The entire plating solution was poured to a Buchner funnel for filtration and the cake thus collected was washed by spraying distilled water.

### Silver Electroplating

In the same electrolytic reaction tank as used in the gold electroplating, 3 dm³ of a silver plating solution Silva-Brite by N. E. Chemcat Co. (pH 12.5, silver concentration 37 g/dm³) was admitted and maintained at 25° C. The electroless plated powder (resulting from the above electroless copper or nickel plating step) was added to the solution. With agitation at about 100 rpm, an current flow of 10 amperes was conducted for 8 minutes. The entire plating solution was poured to a Buchner funnel for filtration and the cake thus collected was washed by spraying distilled water.

### Comparative Example

Electroless nickel plated powder was obtained by using the same spherical silicon oxide powder as in Examples and following the same electroless nickel plating step as in Examples except that the volume of the plating solution was 4.2 dm³. Immediately thereafter, the powder was dispersed in 135 cm³ of water by agitation, forming a slurry. There was furnished 1.7 dM³ of a plating solution by dissolving 0.011 mol/dm³ of sodium gold (I) sulfite (chemical formula: Na₃Au(SO₃)₂), 0.1 mol/dm³ of sodium sulfite and 0.1 mol/dm³ of malonic acid in water, adjusting to pH 7.2 and heating at a temperature of 65° C. The slurry of the nickel plated powder was added to this plating solution. While stirring was continued, reaction took place for 10 minutes, depositing a displacement gold plating film as the uppermost layer. At the end of reaction, the powder was separated by filtration on a Buchner funnel and washed by spraying about 1 dm³ of water.

### Evaluation of conductive filler powder

Five powder samples were obtained from the foregoing Examples (combinations of electroless Cu or Ni plating with Au or Ag electroplating) and Comparative Example. Each powder sample was vacuum dried at 50° C. for 2 hours before a portion thereof was completely decomposed using hydrofluoric acid and aqua regia for chemical analysis. The results are shown in Table 1. Additionally, a resistivity was computed from the resistance measured by the four terminal method (using SMU-257 current source by Keithley, 1 to 10 mA, and Model 2000 Nanovolt Meter by Keithley). The results are also shown in Table 1.

TABLE 1

| | Thickness | | | | | | Resist |
|---|---|---|---|---|---|---|---|
| | of plating | Composition (wt %) | | | | | -ivity |
| | layer | SiO₂ | Ni | Cu | Au | Ag | (mΩ-cm) |
| Example 1 | Cu 250 nm | 69.7 | | 22.3 | 7.97 | | 1.4 |
| (electro- | Au 42 nm | | | | | | |
| less | | | | | | | |
| Cu | | | | | | | |
| plating + | | | | | | | |
| Au | | | | | | | |
| electro- | | | | | | | |
| plating) | | | | | | | |
| Example 2 | Cu 250 nm | 67.7 | | 21.7 | | 10.6 | 1.3 |
| (electro- | Ag 105 nm | | | | | | |
| less | | | | | | | |
| Cu | | | | | | | |
| plating + | | | | | | | |
| Ag | | | | | | | |
| electro- | | | | | | | |
| plating) | | | | | | | |
| Example 3 | Ni 250 nm | 69.6 | 21.1 | | 7.95 | | 3.6 |
| (electro- | Au 42 nm | | | | | | |
| less | | | | | | | |
| Ni | | | | | | | |
| plating + | | | | | | | |
| Au | | | | | | | |
| electro- | | | | | | | |
| plating) | | | | | | | |
| Example 4 | Ni 250 nm | 67.8 | 20.5 | | | 10.6 | 3.1 |
| (electro- | Ag 104 nm | | | | | | |
| less | | | | | | | |
| Ni | | | | | | | |
| plating + | | | | | | | |
| Ag | | | | | | | |
| electro- | | | | | | | |
| plating) | | | | | | | |
| Compara- | Ni 250 nm | 69.1 | 21.2 | | 8.00 | | 7.9 |
| tive | Au 43 nm | | | | | | |
| Example | | | | | | | |
| (electro- | | | | | | | |
| less | | | | | | | |
| Ni | | | | | | | |
| plating + | | | | | | | |
| electro- | | | | | | | |
| less | | | | | | | |
| Au | | | | | | | |
| plating) | | | | | | | |

A comparison of Example 3 with Comparative Example reveals that the sample of Example 3 has a lower resistivity although they are substantially equal in gold content or thickness and nickel content or thickness. Example 1 has the construction of gold coating on copper coating which is difficult to achieve with the prior art displacement gold plating because of a slow reaction rate and frequent termination, and has a low resistivity reflecting the high conductivity of copper. Examples 2 and 4 demonstrate that the dual coats having an upper layer of silver are also accomplished by the invention and they exhibit a low resistivity.

There has been described a conductive particle powder having a high conductivity, improved durability, especially oxidation resistance, and a relatively low specific gravity, which is useful as a filler in the industry.

Japanese Patent Application No. 2000-141634 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A conductive filler comprising non-conductive particles which are coated on their surface with a plating layer of copper, copper alloy, nickel or nickel alloy, which is, in turn, coated with an electroplating layer.

2. The conductive filler of claim 1 wherein the electroplating layer is of gold, gold alloy, silver or silver alloy.

3. The conductive filler of claim 1 wherein the non-conductive particles are selected from the group consisting of silicon oxide, aluminum oxide, titanium oxide, zirconia, rare earth oxides, yttrium oxide, mica, diatomaceous earth, sodium silicate glass, polyurethane, polystyrene, polycarbonate, phenolic resin, polyamide, polyimide, silicone resin and epoxy resin.

4. The conductive filler of claim 1 having a resistivity of up to 15 m Ω-cm.

5. A method for preparing the conductive filler of claim 1, comprising the steps of:
forming a plating layer of copper, copper alloy, nickel or nickel alloy on surfaces of non-conductive particles,
feeding and dispersing the coated particles in an electroplating solution, and
effecting electroplating at a cathodic current density of 0.01 to 10 A/dm².
